(19) United States
(12) Patent Application Publication
(10) Pub. No.: US 2011/0083068 A1
(43) Pub. Date: Apr. 7, 2011

(54) MANAGING DIGITAL ANNOTATIONS FROM DIVERSE MEDIA FORMATS HAVING SIMILAR CONTENT

(75) Inventors: Yuk L. Chan, Poughkeepsie, NY (US); Roan A. Dawkins, Poughkeepsie, NY (US); Saheem Granados, Poughkeepsie, NY (US); Jessie Yu, Poughkeepsie, NY (US)

(73) Assignee: INTERNATIONAL BUSINESS MACHINES CORPORATION, Armonk, NY (US)

(21) Appl. No.: 12/571,871

(22) Filed: Oct. 1, 2009

(51) Int. Cl. G06F 17/00; G06F 17/30

(52) U.S. Cl. 715/230; 707/E17.009

(57) ABSTRACT

A method of managing annotations in digital media includes receiving an input of at least two media files. Each of the at least two media files includes a media format and contains primary content and annotated content. The method also requires creating a merge file having a single media format with the merge file including all of the primary content from each of the at least two media files, identifying the annotated content from each of the at least two media files, and adding the annotated content from each of the at least two media files to the merge file.

### BACKGROUND

The present invention relates to digital media and, more particularly, to merging digital annotations embedded in diverse binary formats having similar content.

There currently exist numerous binary formats, such as, wave-form audio (.wav), Windows® media file (.wmv), mp3 and the like, for digital media. Each format requires a specific device that allows a user to listen to/view content. No single device support all formats, thus a user that requires listening to/viewing media files saved in diverse formats must utilize multiple media devices and listen to similar content more than once. In addition to providing a playback feature, many devices allow a user to insert bookmarks into the digital media. Often times, the bookmarks are associated with, for example, verbal and/or text based annotations. In order to listen to/view annotations from multiple users, each using a different media format, multiple media devices are required. Moreover, if the annotations all apply to similar content, a reviewer will be required to listen to/view the same content multiple times.

### SUMMARY

According to one embodiment of the present invention, a method of managing annotations in digital media includes receiving an input of at least two media files. Each of the at least two media files includes a media format and contains primary content and annotated content. The method also requires creating a merge file having a single media format with the merge file including all of the primary content from each of the at least two media files, identifying the annotated content from each of the at least two media files, and adding the annotated content from each of the at least two media files to the merge file.

System and computer program products are also described and claimed herein.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a digital media annotation management system in accordance with an exemplary embodiment;

FIG. 2 is a flow diagram illustrating a method of managing digital annotations from diverse medial formats in accordance with an exemplary embodiment; and

FIG. 3 is a block diagram of a general-purpose computer configured and disposed to manage digital annotations from diverse media content in accordance with an exemplary embodiment.

### DETAILED DESCRIPTION

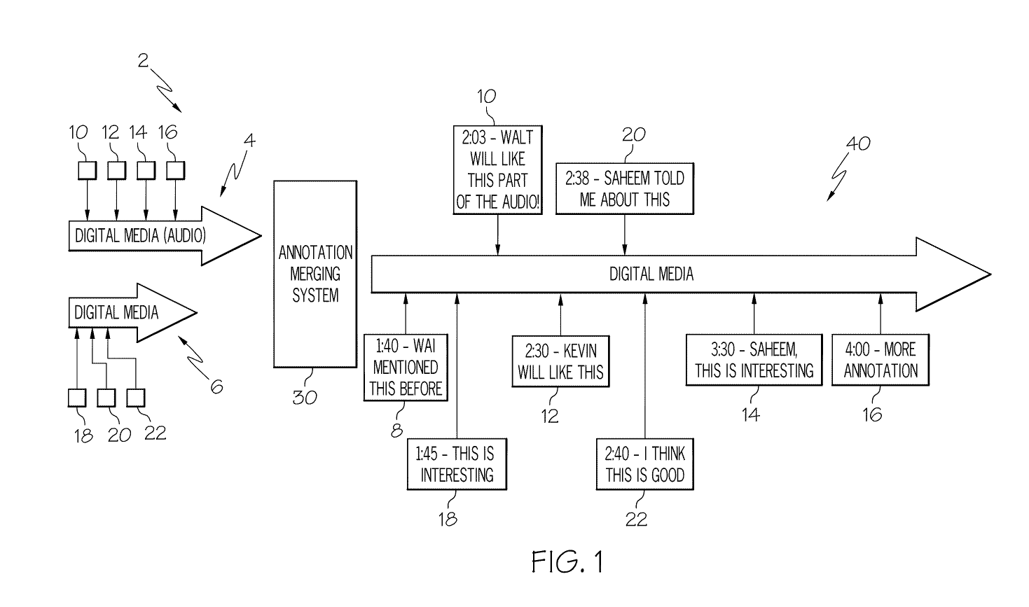

With reference to FIG. 1, a digital media annotation management system in accordance with an exemplary embodiment is indicated generally at 2. Digital media annotation management system 2 manages streams of digital media such as indicated at 4 and 6. Digital media streams 4 and 6 include similar content and are embodied in diverse media formats. Of course, it should be understood that digital media annotation management system 2 also manages digital media contained in similar formats. In any event, digital media stream 4 includes a first set of primary content, which can be in the form of either audio or video. Second digital media stream 6 includes a second set of primary content which, can also be in the form of either audio or video. In accordance with one aspect of the invention, each digital media stream 4 and 6 includes identical sets of primary content. However, it should be understood that primary content of second digital media stream 6 can embody only a subset of the primary contents contained in digital media stream 4. More specifically, one of the digital media streams 4 and 6 can simply be a portion of the other. In any event, each digital media stream 4 and 6 also includes a corresponding set of annotated content. That is, in the exemplary embodiment shown, digital media stream 4 includes a plurality of annotations 10-16 that occur periodically throughout the duration of the primary content. Similarly second digital media stream 6 includes a set of annotations 18-22 that occur periodically throughout the primary content. The set of annotations may include text and/or audio and will usually relates to the subject matter embodied in the primary content.

In order to avoid employing multiple digital media play back devices to listen to digital media streams 4 and 6 and the associated annotated content 10-16 and 18-22, digital media annotation management system 2 includes an annotation merging system 30. More specifically, annotation merging system 30 receives multiple digital media streams having annotations and similar primary content and 6 outputs a merged digital media stream 40 having the annotated content from each input stream. As will be discussed more fully below, annotation merging system 30 determines the content and location of each annotation for each input digital media stream. The resulting merged digital stream 40 includes, in order, all of the annotations from each input digital media stream.

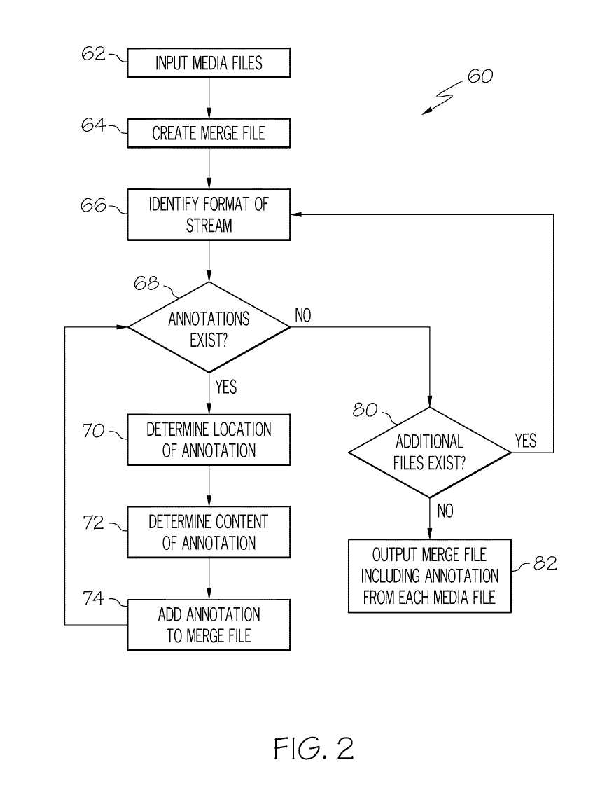

Reference will now be made to FIG. 2 in describing a method 60 of managing annotations in digital media in accordance with an exemplary embodiment. As shown, media files are initially input to annotation merging system 30 as indicated in block 62. Annotation merging system 30 creates a merge file containing the primary content of the input digital media streams as indicated in block 64. At this point, annotation merging system 30 determines the format for an input media stream as indicated in block 66 and whether annotations exist in the input media stream as indicated in block 68. If annotations are found, a location of the first annotation is determined in block 70. In accordance with one aspect of the exemplary embodiment, the location of the annotation in, for example an audio file, is identified by first converting the primary content to text. If an annotation “A” is associated with line “x” of the text, and the merge file also includes a line “x”, then line “x” of the merge file is annotated with “A”. Of course other algorithms for locating annotations in audio, video and/or text files can also be employed. After determining location, the content is collected, be it audio or text, in block 72. The content and location of the annotation is then input to the merge file as indicated in block 74. When input to the merge file, the annotation remains associated with the original sentence or location of the original audio or text. Annotation merging system 30 then determines whether additional annotations exist in block 68. If no further annotations exist, annotation merging system 30 determines whether additional files exist in block 80. If additional files, e.g., data streams exist, the format of the stream is identified in block 66 and the annotations are identified, cataloged and added to the merge file in block 74.

When all files are evaluated, and all annotations added to the merge file in proper order, the merge file is output as indicated in block 82. The merge file, as indicated above, includes all the annotations from each input digital media stream in a single media format. In this manner, a user can listen to the primary content of the digital media as well as annotations from multiple sources from a variety of different sources using a single playback device. That is, instead of listening to multiple digital media streams each having similar primary content and different annotations, a user can now listen to a single digital media stream having the primary content and a plurality of annotations from a variety of sources originally in different formats.

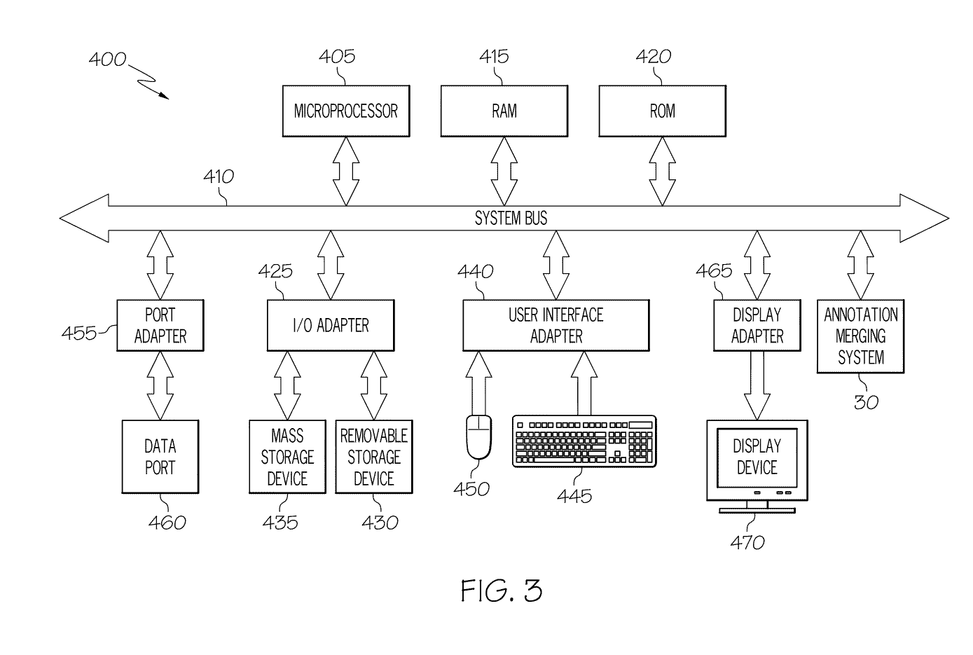

Generally, the method of managing annotations in digital media described herein is practiced with a general-purpose computer and the method may be coded as a set of instructions on removable or hard media for use by the general-purpose computer. FIG. 3 is a schematic block diagram of a general-purpose computer system 400 suitable for practicing the present invention embodiments. In FIG. 3, computer system 400 has at least one microprocessor or central processing unit (CPU) 405. CPU 405 is interconnected via a system bus 410 to a random access memory device (RAM) 415, a read-only memory device (ROM) 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460, a display adapter 465 for connecting a display device 470. In addition, system bus 410 is linked to annotation merging system 30.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives. Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using keyboard 445. Once entered, the computer program is executed causing the computer to manage annotations.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagram(s) depicted herein is just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of managing annotations in digital media, the method comprising:
receiving an input of at least two media files, each of the at least two media files having a media format and containing primary content and annotated content;
creating a merge file having a single media format, the merge file including all of the primary content from each of the at least two media files;
identifying the annotated content from each of the at least two media files; and
adding the annotated content from each of the at least two media files to the merge file.

2. The method of claim 1, wherein the at least two media files have a different media format.

3. The method of claim 1, wherein identifying the annotated content from each of the at least two media files includes identifying text associated with the annotated content.

4. The method of claim 1, wherein identifying the annotated content from each of the at least two media files includes identifying audio associated with the annotated content.

5. The method of claim 1, wherein identifying the annotated content from each of the at least two media files includes identifying a location of annotated text within the media file.

6. The method of claim 1, wherein identifying the annotated content from each of the at least two media files includes identifying a location of annotated audio within the media file.

7. The method of claim 6, wherein identifying the annotated content from each of the at least two media files includes:
converting the primary content to a text file;
identifying a line in the text file associated with the annotated content;
locating a line in the merge file substantially identical to the line in the text file associated with the annotated content; and
add the annotation to the line in the merge file.

8. The method of claim 1, wherein the at least two media files include at least two audio files, each of the at least two audio files having a different media format.

9. The method of claim 1, wherein the at least two media files include at least two video files, each of the at least two video files having a different media format.

10. The method of claim 1, wherein the at least two media files include a first media file having a first set of primary content and a second media file having a second set of primary content, the second set of primary content being a subset of the first set of primary content.

11. The method of claim 1, wherein adding the annotated content from each of the at least two media files includes adding a first set of annotated content to the merge file from one of the at least two media files and a second set of annotated content to the merge file from another of the at least two media files, the first set of annotated content being distinct from the second set of annotated content.

12. A system for managing annotations in digital media, the system comprising:
a central processing unit (CPU), said CPU being interconnected functionally via a system bus to:
at least one memory device having stored thereupon a set of instructions which, when executed by said CPU, causes said system to:
create a merge file having a single media format, the merge file including all primary content from at least two media files;
identify annotated content from each of the at least two media files; and
add the annotated content from each of the at least two media files to the merge file.

13. The system of claim 12, wherein the set of instructions when executed by said CPU, causes said system to: identify text associated with the annotated content.

14. The system of claim 12, wherein the set of instructions when executed by said CPU, causes said system to: identify audio associated with the annotated content.

15. The system of claim 12, wherein the set of instructions when executed by said CPU, causes said system to: identify a location of annotated text within the media file.

16. The system of claim 12, wherein the set of instructions when executed by said CPU, causes said system to: identify a location of annotated audio within the media file.

17. A computer program product comprising:
a computer usable medium including a computer readable program, wherein the computer readable program when executed on a computer causes the computer to:
create a merge file having a single media format, the merge file including all primary content from at least two media files;
identify annotated content from each of the at least two media files; and
add the annotated content from each of the at least two media files to the merge file.

18. The computer program product according to claim 17, wherein the computer readable program when executed on a computer causes the computer to: identify text associated with the annotated content.

19. The computer program product according to claim 17, wherein the computer readable program when executed on a computer causes the computer to: identify a location of annotated text within the media file.

20. The computer program product according to claim 17, wherein the computer readable program when executed on a computer causes the computer to: identify a location of annotated audio within the media file.
